(19) United States
(12) Patent Application Publication
(10) Pub. No.: US 2013/0068799 A1
(43) Pub. Date: Mar. 21, 2013

(54) RETRACTABLE SPOUT ASSEMBLIES FOR CONTAINERS, AND CONTAINERS HAVING SUCH ASSEMBLIES MOUNTED THEREIN

(71) Applicant: Doron RIGEL, Moshave Aviel - Doar-Na Menashe (IL)

(72) Inventor: Doron RIGEL, Moshave Aviel - Doar-Na Menashe (IL)

(21) Appl. No.: 13/235,581

(22) Filed: Sep. 19, 2011

(51) Int. Cl. B67D 3/00

(52) U.S. Cl. 222/481; 222/537; 222/526

(57) ABSTRACT

A retractable spout assembly for a container having a dispensing opening for dispensing contents from the container, the retractable spout assembly includes a mounting member configured to be fixedly mounted in the dispensing opening; and a spout carried by the mounting member and movable with respect thereto from a retracted position within the container to an extended position extending outwardly of the container for use in dispensing contents of the container; wherein the retractable spout assembly further includes a cap removably attached directly to the mounting member and configured such that, when the cap is attached to the mounting member, the cap closes the spout and retains the spout in its retracted position, and when the cap is removed from the mounting member, the cap opens the spout and permits the spout to move to its extended position for use in dispensing the contents of the container.

### FIELD AND BACKGROUND OF THE INVENTION

The present invention relates to retractable spout assemblies for use in dispensing pourable material from a container. The invention also relates to containers equipped with such novel retractable spout assemblies.

Retractable spout assemblies are known for application to the neck of bottles in order to facilitate the dispensing of the bottle's contents. Examples of such known retractable spout assemblies are described in my prior U.S. Pat. Nos. 6,026,994 and 6,976,610. This type of retractable spout assembly has heretofore been used only with respect to bottles, such as those for holding and dispensing alcoholic and non-alcoholic beverages, olive oil, and other liquids.

There are many flowable materials, however, that are provided not in bottles, but rather in cans or other similar type containers, such as those including cylindrical sidewalls closed at their opposite ends by end walls. In order to dispense contents from the container, it is necessary to puncture one of the end walls. For this purpose, the end walls to be punctured is generally provided with a tab which is to be grasped and forcibly moved in order to puncture the end wall. Previously, such tabs were forcibly pulled out of the end wall to form the opening, but for health and safety purposes at the present time such tabs are merely pivoted to puncture the end wall and remain attached to the end wall. In either case, considerable force is needed in order to puncture the end wall, and moreover, when the end wall has thus been punctured, the container can no longer be reclosed.

### OBJECTS AND BRIEF SUMMARY OF THE INVENTION

One object of the present invention is to provide a retractable spout assembly particularly useful with containers of the foregoing type which obviate the need for manually puncturing the container and also permit such containers, when once opened, to be reclosed if desired. Another object of the invention is to provide a container equipped with such a retractable spout assembly.

According to one aspect of the present invention, there is provided a retractable spout assembly for a container having a dispensing opening for dispensing contents from the container, the retractable spout assembly comprising: a mounting member configured to be fixedly mounted in the dispensing opening; and a spout carried by the mounting member and movable with respect thereto, when mounted in the dispensing opening, from a retracted position within the container to an extended position extending outwardly of the container for use in dispensing contents of the container; characterized in that the retractable spout assembly further comprises a cap removably attached directly to the mounting member and configured such that, when the cap is attached to the mounting member, the cap closes the spout and retains the spout in its retracted position, and when the cap is removed from the mounting member, the cap opens the spout and permits the spout to move to its extended position for use in dispensing the contents of the container.

In one described preferred embodiment, the mounting member includes a cylindrical body section having an outer surface configured to fixedly engage the edge of the dispensing opening, and an outer end face formed with an annular recess for removably receiving the cap. In a second described preferred embodiment, the mounting member includes a cylindrical body section configured to fixedly engage the edge of the dispensing opening in the container, and having an upstanding cylindrical surface for removably receiving the cap.

According to another aspect of the present invention, there is provided a container containing a flowable material and formed with a dispensing opening for dispensing container contents therefrom, in combination with a retractable spout assembly mounted in the dispensing opening; the retractable spout assembly comprising: a mounting member configured to be fixedly mounted in the dispensing opening; and a spout carried by the mounting member and movable with respect thereto, when mounted in the dispensing opening, from a retracted position within the container to an extended position extending outwardly of the container for use in dispensing contents of the container; characterized in that the retractable spout assembly further comprises a cap removably attached directly to the mounting member and configured such that, when the cap is attached to the mounting member, the cap closes the spout and retains the spout in its retracted position, and when the cap is removed from the mounting member, the cap opens the spout and permits the spout to move to its extended position for use in dispensing the contents of the container.

It will thus be seen that when retractable spout assemblies are used there is no need for manually punching out a hole in the container in order to dispense contents therefrom; in addition, they also enable an opened container to be reclosed if desired. Further, since the cap is part of the retractable spout assembly, it is automatically mounted with the assembly, and therefore does not have to be separately mounted to the bottle neck as in prior devices.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is a partial, sectional view of one form of retractable spout assembly constructed in accordance with the present invention mounted in a container, the spout being shown in its retracted position;

FIG. 2 is a similar view as FIG. 1, but showing the spout in its extended position for dispensing contents from the container;

FIG. 3 is a view, similar to that of FIG. 1, but illustrating a second form of retractable spout assembly constructed in accordance with the present invention;

FIG. 4 is a view of the assembly of FIG. 3, but with the cap removed;

FIG. 5 is a 3-dimensional view of the retractable spout assembly of FIGS. 3 and 4;

FIG. 6 is a longitudinal sectional view of the retractable spout assembly of FIG. 5, with the cap applied; and

FIG. 7 is a top plan view of the retractable spout assembly of FIG. 6, with the cap removed.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF A PREFERRED EMBODIMENT

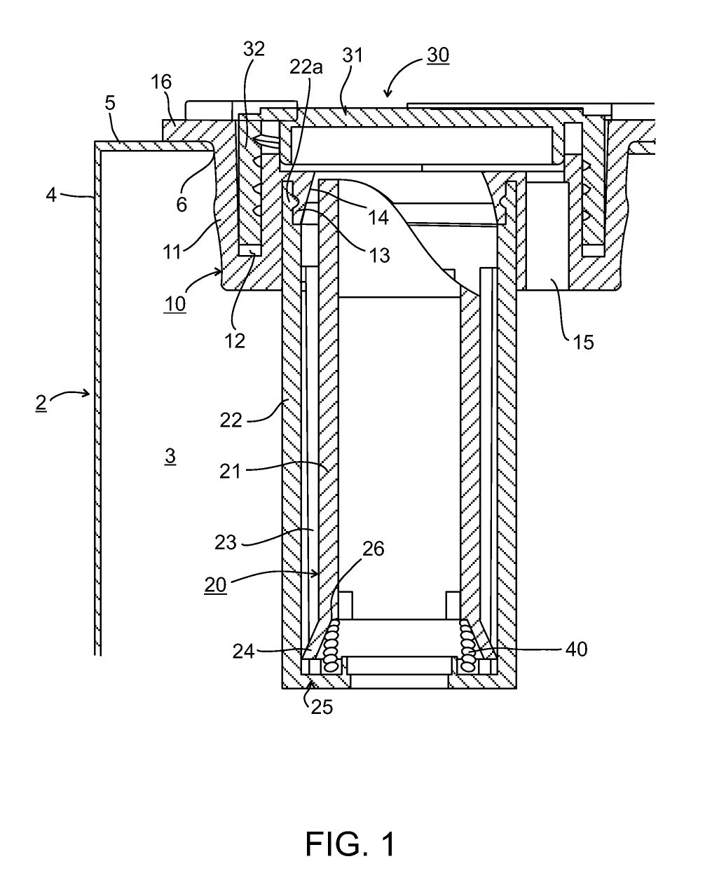

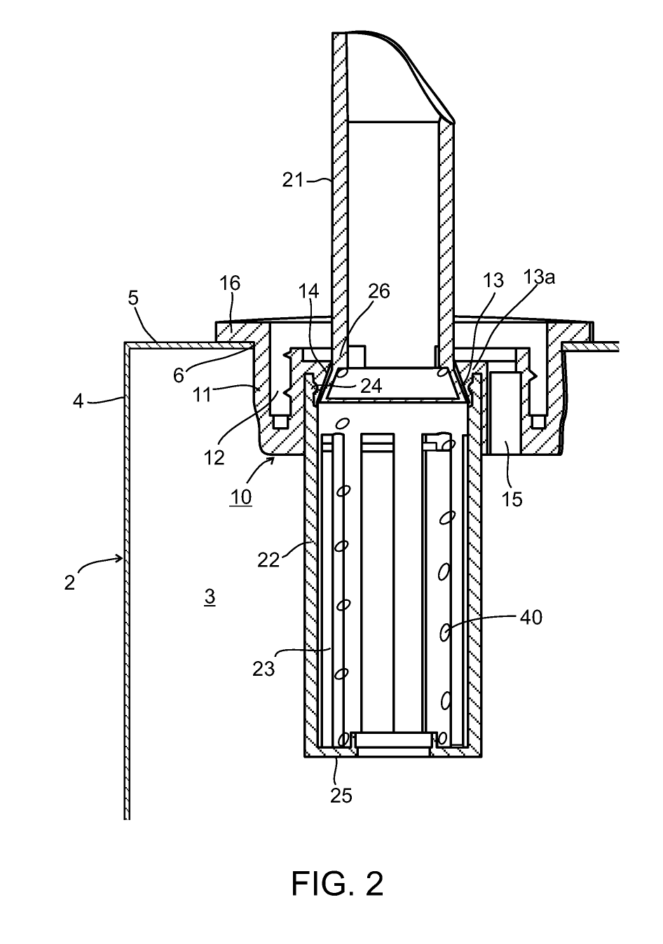

### The Embodiment of FIGS. 1 and 2

FIGS. 1 and 2 of the drawings illustrate a container, generally designated 2, filled with a pourable contents 3, such as liquid beverage, lubricating oil, a pourable particulate material such as sugar, salt, etc. Container 2 may be of a conventional can-type container, including a cylindrical side wall 4 closed at its opposite ends by end walls, e.g., 5. In a conventional container of this type, it is necessary to puncture a hole through end wall 5 in order to dispense contents from the container. In addition, such containers are used only with respect to material to be totally consumed at one time, since re-closing the container is not practical.

According to the present invention, end wall 5 of container 4 is formed with an opening 6 for receiving a retractable spout assembly, generally designated 10, carrying a spout, generally designated 20, movable from a retracted position as shown in FIG. 1, to an extended position as shown in FIG. 2. Spout assembly 10 further includes a cap, generally designated 30, which when attached closes the upper open end of spout 20 and also retains the spout in its retracted (FIG. 1) position. When cap 30 is removed, spout 20 is urged to its extended position, shown in FIG. 2, by a spring 40 within the retractable spout assembly 10.

More particularly, mounting member 10 includes a cylindrical body section 11 having an outer surface configured to fixedly engage the edge of opening 6 formed in the container end wall 5. Body section 11 has an outer face formed with a circular recess 12 for receiving cap 30. Mounting member 10 includes the retractable spout assembly 20 when the mounting member is mounted within end wall opening 6 of the container 4.

The retractable spout assembly 20 includes a spout 21 movably mounted within a spout housing 22. Spout housing 22 is of cylindrical configuration and includes an outer (upper, FIGS. 1 and 2) end fixed within mounting member 10. For this purpose, the mounting member is integrally formed with an annular locking element 13 formed on its outer surface with an annular groove 14, and the upper end of spout housing 22 is formed with an annular rib 22a received within groove 14 of the locking element.

As indicated earlier, spout housing 22 fixed within mounting member 10 is of cylindrical configuration. It is formed with a sidewall having one or more axially-extending slots 23 to establish flow paths for the container contents 3 when the spout 21 is in its extended position to dispense the container contents, as shown in FIG. 2.

The annular locking element 13 of mounting member 10 includes a tapered inner surface, as shown at 14, engageable with a tapered end wall surface 24 of the movable spout 21, when the spout is in its extended position. Thus, when the spout is in its extended position, the two contacting tapered surfaces 14, 24, limit the outward movement of the spout, and also act as a seal to prevent leakage from the container as container contents are dispensed via the spout.

The inner end of spout housing 22 is formed with an apertured end wall 25 which engages one end of spring 40. The opposite end of the spring engages a seat 26 formed in the inner end of spout 21 at its juncture with its tapered end wall surface 24.

Mounting member 10 is further formed with an outwardly-extending annular flange 16 engageable with the outer surface of end wall 5 of the container 2 formed with the opening 6 receiving the mounting member. In addition, mounting member 10 further includes an opening 15 therethrough laterally of the spout housing 22. Opening 15 defines an air-return passageway for returning air into the container 2 as contents thereof are dispensed via the spout 21 when in its extended (FIG. 2) position.

Cap 30, removably attachable to the open end of mounting member 10, includes a head 31 closing the upper end of spout housing 22, and a depending skirt 32 receivable within circular recess 12 formed in the outer surface of the mounting member. Skirt 32 is adapted to be fixedly received within the circular recess 12, e.g. by press-fitting, threaded fitting, or the like.

The manner of using the retractable spout assembly in the illustrated drawings will be apparent from the above description. Its various parts may be assembled, as shown in FIG. 1, and the assembly fixed within opening 6 of the container end wall 5. For example, end wall 5, with the retractable spout assembly fixed therein, could be attached to container 4 after the container has been filled with its contents 3. Alternatively, end wall 5 with retractable spout assembly 2 mounted therein could be attached to the container before being filled with its contents 3, whereupon the retractable spout assembly, with cap 30 removed, could be used for filling the container.

In either case, after the container 2 has been filled with its contents 3, and the end wall 5 with the retractable spout assembly mounted therein attached to the container, cap 30 will close the upper end of the spout assembly and will retain the spout 21 in its retracted position as shown in FIG. 1. Whenever it is desired to dispense contents from the container, cap 30 is removed, whereupon the spout 21 will be automatically moved to its extended position by spring 40, thereby permitting dispensing of the container contents via the spout. If it is desired to reclose the container, cap 30 is pressed against the outer end of spout 21 to force it to its retracted position within the container (FIG. 1), and the cap is fixed in position, as shown in FIG. 2, to thereby retain the spout 21 in its retracted position.

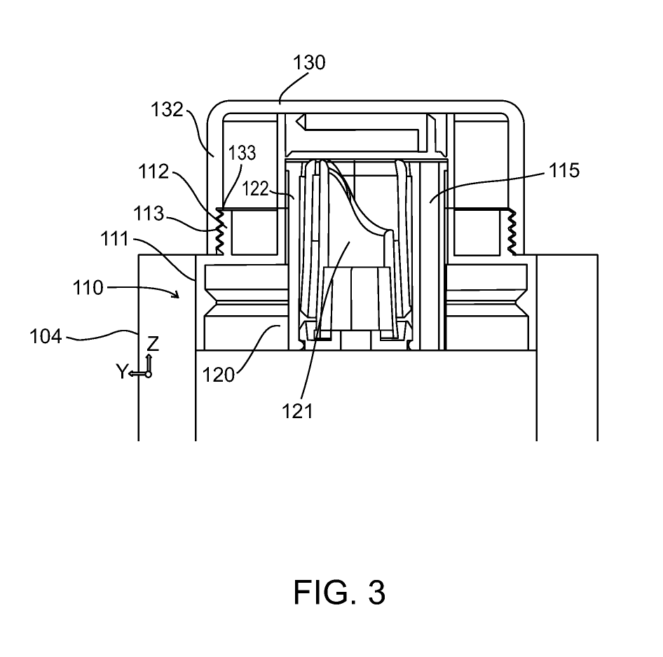

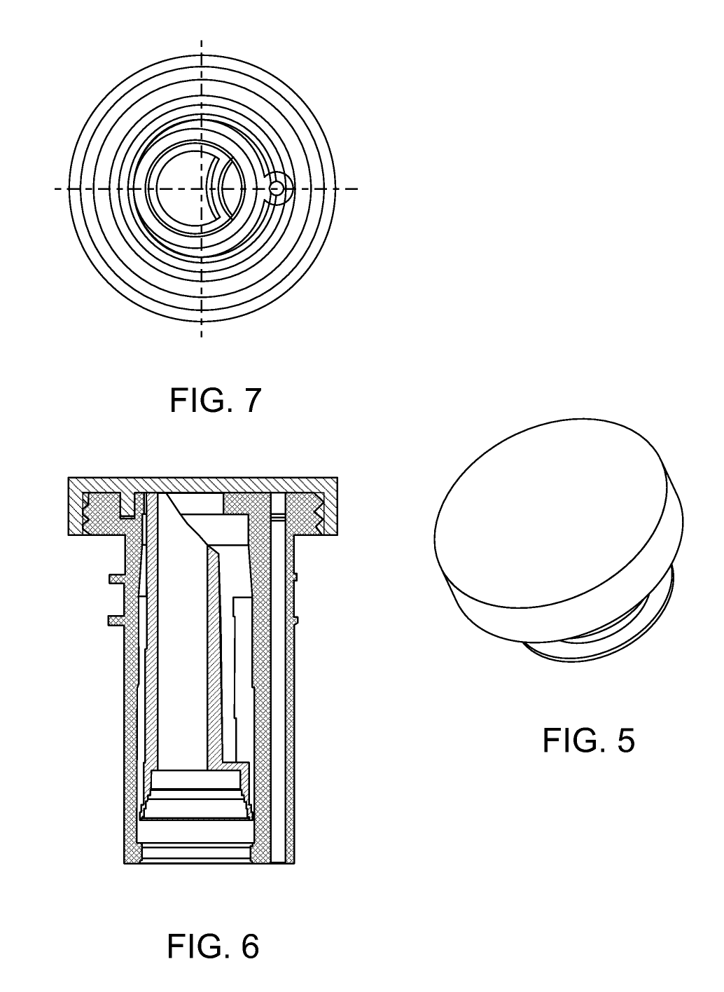

### The Embodiment of FIGS. 3-7

This embodiment of the invention utilizes a slightly different manner of mounting the cap directly to the mounting member, rather than to the bottle neck as heretofore done. In this embodiment, the container is a bottle, generally designed 102, having a neck 104, in which the mounting member, therein designated 120, is fixedly mounted and carries the retractable spout assembly, generally designated 120, with the cap 130 applied directly to the mounting member 110. It will appreciated that the retractable spout assembly illustrated in FIGS. 3-5 preferably also includes a spring, corresponding to spring 40 in the embodiment of FIGS. 1 and 2, for automatically extending the spout to its extended position when the cap is removed.

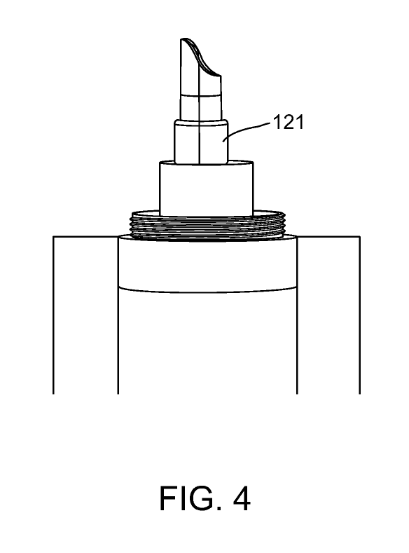

Thus, as clearly seen in FIGS. 3 and 4, the mounting member 110 includes a cylindrical body section 111 configured to fixedly engage the edge of the dispensing opening in the container, in this case the inner surface of the bottle neck 104. Mounting member 110 is formed with an upstanding cylindrical surface 112 having external threads 113. In addition, cap 130 is formed with a depending annular skirt 132 having internal threads 133 engaging threads 113 of the mounting member when the cap is applied to the mounting member (FIG. 3).

Retractable spout assembly 120 may otherwise constructed similarly to that described above with respect to FIGS. 1 and 2, to include a spout 121 movable, within a housing 122 fixed within the container, to a retracted position within the container as shown in FIG. 3, or to an extended position extending outwardly of the container, as shown in FIG. 4, when the cap 130 is removed. The spout housing 122 fixed within the mounting member 110 may also be of cylindrical configuration and formed with a plurality axially-extending slots to establish flowpaths for the container contents when the spout is in its extended position as shown in FIG. 4. In addition, the mounting member 110 is formed with an opening therethrough, shown at 115, laterally of the spout housing 122, for defining an air-return passageway for returning air into the container as contents thereof are being dispensed via the spout when in its extended position (FIG. 4).

In substantially all other respects, the retractable spout assembly illustrated in FIGS. 3-7 is of basically the same construction, and operates basically in the same manner, as described above with respect to FIGS. 1 and 2.

While the invention has been described with respect to two preferred embodiments, it will be appreciated that these are set forth merely for purposes of example, and that many other variations, modifications and applications of the invention may be made.

What is claimed is:

1. A retractable spout assembly for a container having a dispensing opening for dispensing contents from the container, the retractable spout assembly comprising:
a mounting member configured to be fixedly mounted in said dispensing opening; and
a spout carried by the mounting member and movable with respect thereto, when mounted in said dispensing opening, from a retracted position within the container to an extended position extending outwardly of the container for use in dispensing contents of the container;
characterized in that said retractable spout assembly further comprises a cap removably attached directly to the mounting member and configured such that, when the cap is attached to the mounting member, the cap closes the spout and retains the spout in its retracted position, and when the cap is removed from the mounting member, the cap opens the spout and permits the spout to move to its extended position for use in dispensing the contents of the container.

2. The retractable spout assembly according to claim 1, wherein said retractable spout assembly further comprises:
a spout housing fixedly received within the mounting member for receiving the movable spout when in its retracted position;
and a spring interposed between the fixed spout housing and the movable spout for urging the spout to its extended position.

3. The retractable spout assembly according to claim 2, wherein the spout housing is formed with a sidewall having a plurality of axially-extending slots to establish flow paths for the container contents when the spout is in its extended position to dispense the contents.

4. The retractable spout assembly according to claim 1, wherein the mounting member includes an opening therethrough laterally of the spout housing for defining an air-return passageway for returning air into the container as contents thereof are being dispensed via the spout when in its extended position.

5. The retractable spout assembly according to claim 1, wherein the mounting member includes a cylindrical body section having an outer surface configured to fixedly engage the edge of the dispensing opening, and an outer end face formed with an annular recess for removably receiving the cap.

6. The retractable spout assembly according to claim 5, wherein the cap is formed with a depending annular skirt removably receivable within the annular recess in the outer end face of the mounting member.

7. The retractable spout assembly according to claim 5, wherein the mounting member further includes an annular locking element for engaging and locking the spout housing within the mounting member.

8. The retractable spout assembly according to claim 7, wherein the outer end of the spout housing is formed with an internal annular rib, and the locking element is formed with an inner annular recess for receiving the annular rib and for locking the spout housing within the mounting member.

9. The retractable spout assembly according to claim 7, wherein the annular locking element includes a tapered inner surface engageable with a tapered outer surface of the movable spout when in its extended position for limiting the outward movement of the spout, and for sealing the contacting surfaces of the mounting member and the spout in the extended position of the spout.

10. The retractable spout assembly according to claim 1, wherein the mounting member includes an outwardly-extending annular flange engageable with the outer surface of the end wall formed with the opening therethrough.

11. The retractable spout assembly according to claim 1, wherein the mounting member includes a cylindrical body section configured to fixedly engage the edge of said dispensing opening in the container, and having an upstanding cylindrical surface for removably receiving the cap.

12. The retractable spout assembly according to claim 11, wherein the cap is formed with a depending annular skirt removably receivable around said upstanding cylindrical surface of the mounting member.

13. The retractable spout assembly according to claim 12, wherein said annular skirt of the cap, and said upstanding cylindrical surface of the mounting member, are formed with interengaging threads.

14. A container containing a flowable material, and formed with a dispensing opening for dispensing container contents therefrom, in combination with a retractable spout assembly mounted in said dispensing opening; said retractable spout assembly comprising:
a mounting member configured to be fixedly mounted in said dispensing opening; and
a spout carried by the mounting member and movable with respect thereto, when mounted in said dispensing opening, from a retracted position within the container to an extended position extending outwardly of the container for use in dispensing contents of the container;
characterized in that said retractable spout assembly further comprises a cap removably attached directly to the mounting member and configured such that, when the cap is attached to the mounting member, the cap closes the spout and retains the spout in its retracted position, and when the cap is removed from the mounting member, the cap opens the spout and permits the spout to move to its extended position for use in dispensing the contents of the container.

15. The container according to claim 14, wherein the mounting member includes a cylindrical body section having an outer surface configured to fixedly engage the edge of the dispensing opening, and an outer end face formed with an annular recess for removably receiving the cap.

16. The container according to claim 15, wherein the cap is formed with a depending annular skirt removably receivable within the annular recess in the outer end face of the mounting member.

17. The container according to claim 14, wherein the mounting member includes an outwardly-extending annular flange engageable with the outer surface of the end wall formed with the opening therethrough.

18. The container according to claim 17, wherein the mounting member includes a cylindrical body section configured to fixedly engage the edge of said dispensing opening in the container, and having an upstanding cylindrical surface for removably receiving the cap.

19. The container according to claim 17, wherein the cap is formed with a depending annular skirt removably receivable around said upstanding cylindrical surface of the mounting member.

20. The container according to claim 19, wherein said annular skirt of the cap, and said upstanding cylindrical surface of the mounting member, are formed with interengaging threads.
